(19) United States
(12) Patent Application Publication
(10) Pub. No.: US 2012/0140960 A1
(43) Pub. Date: Jun. 7, 2012

(54) INTEGRATED SPEAKER AND HOME THEATER SOUND SYSTEM HAVING THE SAME

(75) Inventor: Dong-uk JANG, Suwon-si (KR)

(73) Assignee: SAMSUNG ELECTRONICS CO., LTD., Suwon-si (KR)

(21) Appl. No.: 13/213,766

(22) Filed: Aug. 19, 2011

(30) Foreign Application Priority Data
Dec. 1, 2010 (KR) 10-2010-0121417

(51) Int. Cl. H04R 5/02

(52) U.S. Cl. 381/307

(57) ABSTRACT

An integrated speaker and a home theater sound system having the same are provided. The integrated speaker includes: a first speaker that is configured to stand on a floor; and a second speaker mounted to an upper end of the first speaker, wherein the second speaker is a height speaker.

### CROSS-REFERENCE TO RELATED APPLICATION

This application claims priority from Korean Patent Application No. 10-2010-0121417, filed on Dec. 1, 2010 in the Korean Intellectual Property Office, the disclosure of which is incorporated herein by reference in its entirety.

### BACKGROUND

1. Field

Apparatuses and methods consistent with exemplary embodiments relate to an integrated speaker and a home theater sound system having the same, and more particularly, to an integrated speaker which integrates a side speaker into a front speaker or a rear speaker and a home theater sound system having the same.

2. Description of the Related Art

Generally, a home theater, by providing a large screen and a surround sound, is an image/sound system and provides a cinema atmosphere at home.

A home theater sound system includes a number of speakers disposed in a three-dimensional sound field to provide a surround sound effect and eight speakers in total, i.e., a front-left speaker, a front-right speaker, a center speaker, a sub-woofer, a rear-left speaker, a rear-right speaker, a height-left speaker and a height-right speaker, in a manner of 7.1 channels.

Generally, height speakers (a height-left speaker and a height-right speaker) are fixed on a front wall by an auxiliary method such as a bracket. However, in this case, an installation of the side speakers in an inconvenience to a user and is difficult for a sound-emitting direction of the side speakers to be adjusted appropriately according to listening conditions or a user's preferences.

### SUMMARY

One or more exemplary embodiments provide an integrated speaker and a home theater sound system having the same that ease inconvenience of an installation of a height speaker and a sound-emitting direction of the height speakers are adjustable according to listening conditions and a listener's preferences.

According to an aspect of an exemplary embodiment, there is provided an integrated speaker arranged in a home theater sound system, the integrated speaker including: a first speaker which is configured to stand on a floor; and a second speaker mounted to an upper end of the first speaker, wherein the second speaker is a height speaker.

The first speaker may be a front speaker.

The second speaker may be rotatable around a first rotation axis which is perpendicular to a vertical direction.

The second speaker may be rotatable around a second rotation axis which is parallel to a vertical direction.

The upper end of the first speaker may be a curved surface which has a predetermined curvature, and the integrated speaker may further include a connection unit which connects the first speaker and the second speaker, wherein the connection unit may include: an axis member partly inserted into the first speaker through the curved surface; and a sliding member which is coupled to the second speaker, has a sliding groove which has a long-hole formation and passed by the axis member and has a plate formation which has a same curvature with the curved surface.

The first speaker may be a rear speaker.

According to an aspect of another exemplary embodiment, there is provided a home theater sound system including: an integrated speaker, wherein the integrated speaker may include: a first speaker which is configured to stand on a floor; and a second speaker mounted to an upper end of the first speaker, wherein the second speaker is a height speaker.

The first speaker may be a front speaker.

The second speaker may be rotatable around a first rotation axis which is perpendicular to a vertical direction.

The second speaker may be rotatable around a second rotation axis which is parallel to a vertical direction.

The upper end of the first speaker may be a curved surface which has a predetermined curvature, and the integrated speaker may further include: a connection unit which connects the first speaker and the second speaker, wherein the connection unit may include: an axis member partly inserted into the first speaker through the curved surface; and a sliding member coupled to the second speaker, has a sliding groove which has a long-hole shape and passed by the axis member and has a plate shape which has a same curvature with the curved surface.

The home theater sound system may be applied to a manner of 7.1 channels, and may include: two integrated speakers disposed in a front left location and a front right location; two rear speakers disposed in a rear left location and a rear right location; a center speaker disposed between the two integrated speakers; and a sub-woofer which reinforces reproduction of a low sound.

The first speaker may be a rear speaker.

### BRIEF DESCRIPTION OF THE DRAWINGS

The above and/or other aspects will be more apparent by describing certain exemplary embodiments with reference to the accompanying drawings, in which:

FIG. 1 is a perspective view schematically illustrating a home theater system to which a home theater sound system according to an exemplary embodiment is applied;

FIG. 2 is a concept map showing a connection of a sound system provided in a home theater system in FIG. 1;

FIG. 3 is a perspective view of an integrated speaker disposed on a sound system of a home theater in FIG. 1;

FIG. 4 is a sectional perspective view of an integrated speaker in FIG. 3;

FIG. 5 is a broken out section view of an integrated speaker in FIGS. 3; and

FIGS. 6, 7 and 8 are views to explain rotation motions of a height speaker provided in an integrated speaker in FIG. 3, wherein FIG. 6 is an exemplary embodiment of a perspective view illustrating an initial state, FIG. 7 is an exemplary embodiment of a perspective view illustrating a case where a height speaker is rotated upward from an initial state, and FIG. 8 is an exemplary embodiment of a perspective view illustrating a case where a height speaker is rotated toward a right direction from an initial state.

### DETAILED DESCRIPTION OF EXEMPLARY EMBODIMENTS

Certain exemplary embodiments will now be described in greater detail with reference to the accompanying drawings.

In the following description, the same drawing reference numerals are used for the same elements even in different drawings. The matters defined in the description, such as a detailed construction and elements, are provided to assist in a comprehensive understanding of exemplary embodiments. Thus, it is apparent that an exemplary embodiment can be carried out without those specifically defined matters. Also, well-known functions or constructions are not described in detail since they would obscure the description with unnecessary detail. Expressions such as “at least one of,” when preceding a list of elements, modify the entire list of elements and do not modify the individual elements of the list.

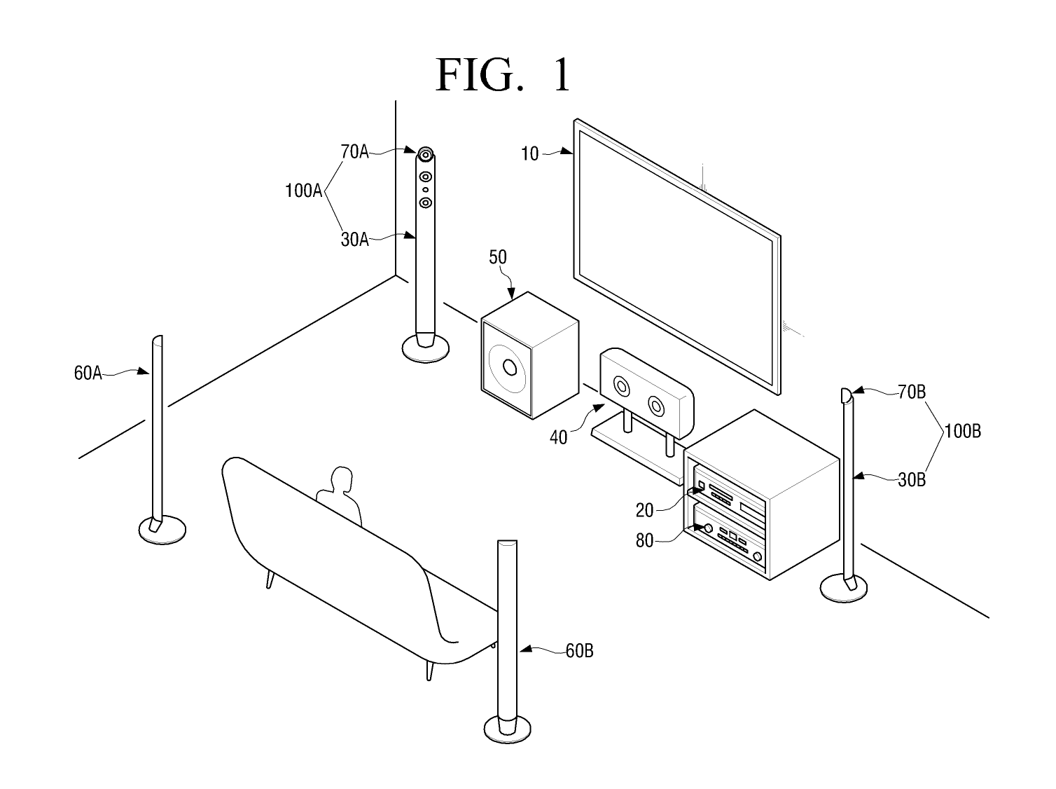

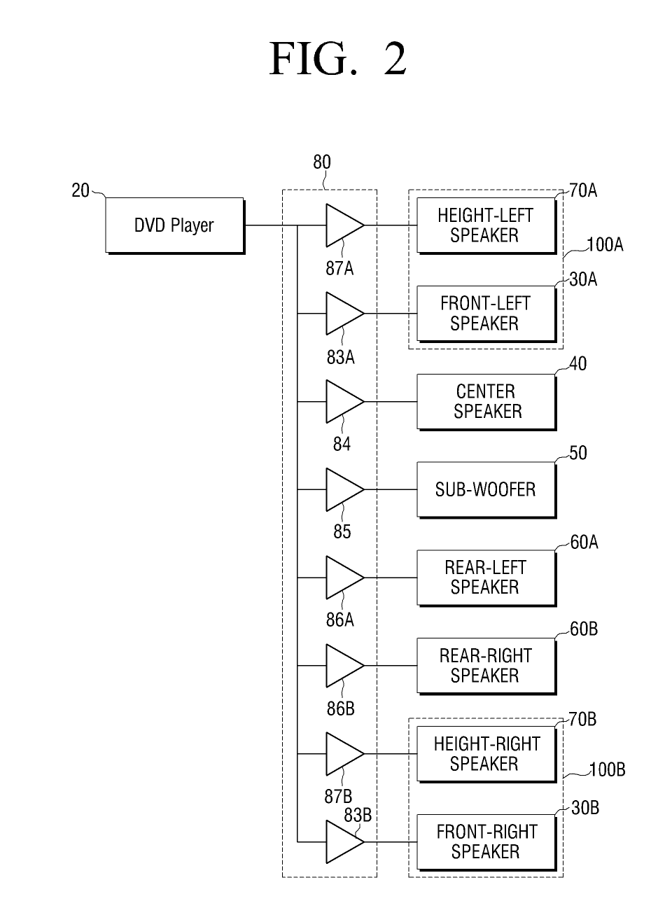

FIG. 1 is a perspective view schematically illustrating a home theater system to which a home theater sound system according to an exemplary embodiment is applied and FIG. 2 is a concept map showing a connection of a sound system provided in a home theater system in FIG. 1.

Referring to FIG. 1, a home theater system includes an imaging system to provide an image and a sound system to provide a sound.

The imaging system includes a television 10 and a digital versatile disc (DVD) player 20. Image information recorded on a DVD may be reproduced via a DVD player 20 and transformed into an image via a television 10. Other alternative exemplary embodiments may provide other reproducing apparatuses such as a Blu-ray player, a digital video recorder (DVR) a videocassette recorder, a set-top box, a personal computer PC, etc., instead of or in addition to a DVD player 20.

A manner of 7.1 channels is applied to the sound system including eight speakers in total, i.e., a front-left speaker 30A, a front-right speaker 30B, a center speaker 40, a sub-woofer 50, a rear-left speaker 60A, a rear-right speaker 60B, a height-left speaker 70A, and a height-right speaker 70B. However, it is understood that another exemplary embodiment is not limited thereto and may be applied, for example, to 7.2 channels or more.

Seven speakers 30A, 30B, 40, 60A, 60B, 70A, and 70B provide a wide frequency range of approximately 20 Hz to 20,000 Hz, and a sub-woofer 50 reinforces a reproduction of a low frequency range of approximately 20 Hz to 120 Hz.

The sound system further includes a receiver 80 to amplify a sound source reproduced by a DVD player 20. Referring to a connection illustrated in FIG. 2, a receiver 80 includes eight amplifiers corresponding to eight speakers, i.e., a front-left amplifier 83A, a front-right amplifier 83B, a center amplifier 84, a sub-woofer amplifier 85, a rear-left amplifier 86A, a rear-right amplifier 86B, a height-left amplifier 87A, and a height-right amplifier 87B. Therefore, sound sources reproduced on a DVD player 20 are amplified by eight amplifiers arranged in a receiver 80 and respectively transmitted to eight speakers.

As illustrated in FIG. 1, a television 10 is between two front speakers, 30A and 30B, disposed separately in front of a listener, a center speaker 40 is between the two front speakers, 30A and 30B, a sub-woofer 50 is between a front-left speaker 30A and a center speaker 40, and two rear speakers, 60A and 60B, are separately behind a listener. It is understood that a sub-woofer 50 is not limited by an installation location. Therefore, even though a sub-woofer 50 is between a front-left speaker 30A and a center speaker 40 in FIG. 1, other interior locations of the sub-woofer 50 are possible.

As illustrated in FIG. 1, a height-left speaker 70A is coupled to an upper end of a front-left speaker 30A, and a height-right speaker 70B is coupled to an upper end of a front-right speaker 30B. Therefore, a front-left speaker 30A and a height-left speaker 70A are integrated as an integrated speaker 100A, and a front-right speaker 30B and a side-right speaker 70B are integrated as another integrated speaker 100B. In the same way, a home theater sound system of an exemplary embodiment differs from related art sound systems as height speakers, 70A and 70B, are not installed on a wall, but are integrated into front speakers, 30A and 30B.

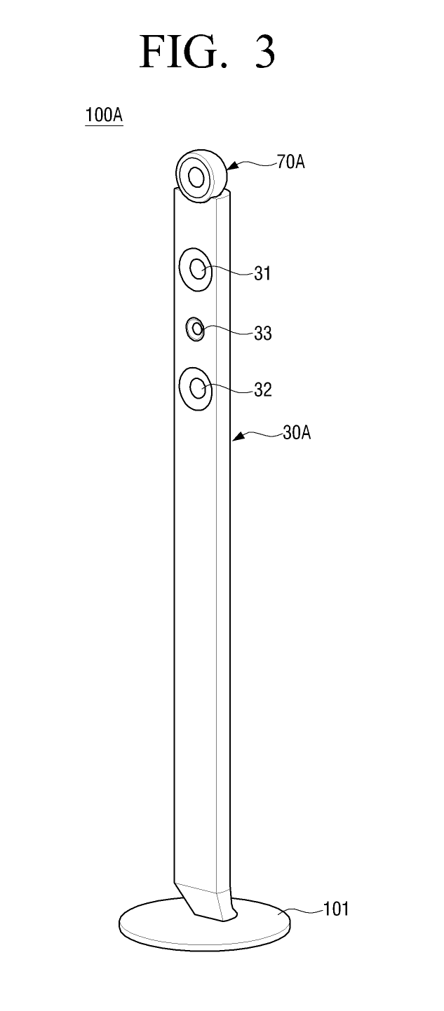

Integrated speakers, 100A and 100B, will be described in more detail with reference to FIGS. 3 to 8. Since structures of two integrated speakers, 100A and 100B, are the same, between the two speakers, an integrated speaker 100A disposed in a front left location will be representatively described and a description of an integrated speaker 100B disposed in a front right location will be omitted.

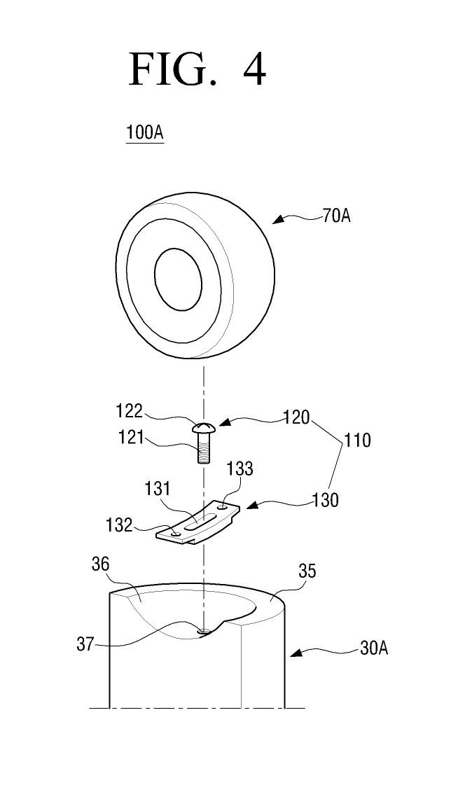

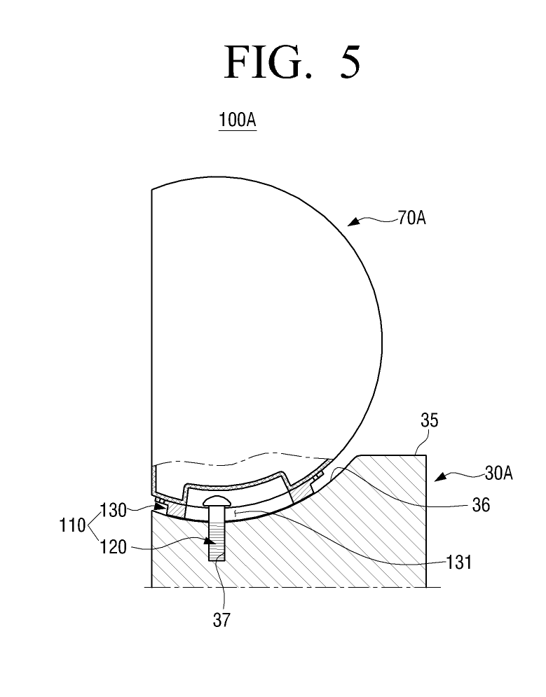

FIG. 3 is a perspective view of an integrated speaker disposed on a sound system of a home theater in FIG. 1, FIG. 4 is a sectional perspective view of an integrated speaker in FIG. 3, and FIG. 5 is a broken out section view of an integrated speaker in FIG. 3.

Referring to FIGS. 3 to 5, an integrated speaker 100A according to an exemplary embodiment includes a front speaker (or a first speaker) 30A, a height speaker (or a second speaker) 70A, a support 101, and a connection unit 110. More specifically, the front speaker 30A corresponds to a front-left speaker 30A and the height speaker 70A corresponds to a height-left speaker 70A.

A front speaker 30A may be supported by a support 101 that allows the front speaker 30A to be disposed on a floor surface. The front speaker 30A may be an upright speaker that configured to stand upright on a floor and has a form of a rod of approximately lm. On an upper end of a front speaker 30A, three drivers, 31, 32, and 33, which output a sound, are provided. Specifically, a driver 33 disposed in the middle of the drivers 31, 32, and 33 corresponds to a tweeter which provides a high frequency, a pair of drivers 31 and 32 disposed above and below the driver 33 correspond to a mid-woofer which provides a sound of a low or middle frequency. The number, type, and deployment of the drivers, 31, 32, and 33 is merely exemplary, and may differ in other exemplary embodiments.

As illustrated in FIGS. 4 and 5, a curved surface 36 which has a predetermined curvature is formed concavely on an upper end 35 of a front speaker 30A. The curved surface 36 corresponds to a portion of a spherical surface and accordingly has predetermined curvature which corresponds to a radius of a sphere. In the middle of the curved surface 36, an insert hole 37 of a predetermined depth is formed.

A height speaker 70A has a form of a hemisphere shape and is mounted on an upper end 35 of a front speaker 30A. In this way, since a height speaker 70A is installed in a integrated way on a front speaker 30A, an installation of the height speaker 70A on an interior wall may be omitted, which may ease inconvenience experienced when a side speaker is installed.

A connection unit 110 connects between a front speaker 30A which corresponds to the first speaker and a height speaker 70A which corresponds to the second speaker. The connection unit 110 includes an axis member 120 and a sliding member 130.

The axis member 120 includes an insert portion 121 and a head portion 122. The insert portion 121 is fixed by being inserted into the insert hole 37 formed on the upper end 35 of the front speaker 30A. For example, a male screw thread is formed on an outer side of an insert portion 121 and a female screw thread is formed on an inner side of an insert hole 37. Therefore, the insert portion 121 of the axis member 120 may be easily fixed into the insert hole 37 by screwing. The head portion 122 is not inserted into the insert hole 37 and is exposed exteriorly.

A sliding member 130 has a form of a plate which has a same curvature with the curved surface 35 of a front speaker 30A. A sliding groove 131 that has a long-hole shape is formed on the sliding member 130. The insert portion 121 of the axis member 120 described above passes the sliding groove 131 of the sliding member 130 and is inserted into the insert hole 37 of the front speaker 30A. On the sliding member 130, a pair of connection holes 132 and 133 is formed. The sliding member 130 is fixed on the height speaker 70A by screws (not illustrated) which pass the connection holes, 132 and 133.

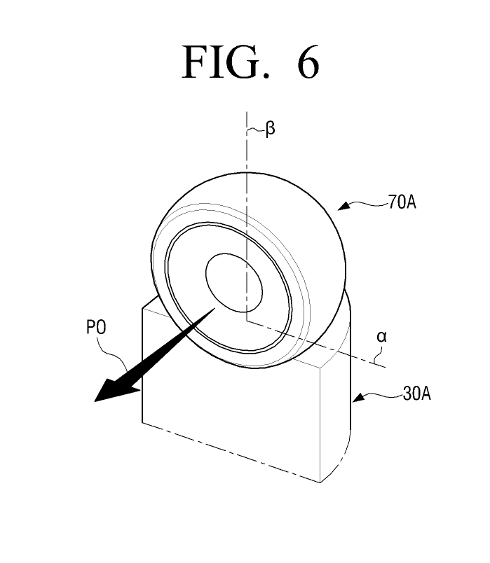

The sliding member 130 of the connection unit 110 is slidable along the curved surface 36 of the front speaker 30A. Therefore, when the sliding member 130 slides along the curved surface 36 of a front speaker 30A, a side speaker 70A (i.e., the height speaker 70A) integrated into a sliding member 130 rotates in up and down directions. Here, the fact that the side speaker 70A rotates in the up and down directions means that the side speaker 70A rotates around a first axis of rotation 4 as shown in FIG. 6) that is perpendicular to a vertical direction.

The sliding member 130 of the connection unit 110 is rotatable around the axis member 120. Therefore, when the sliding member 130 rotates around the axis member 120, the height speaker 70A coupled to the sliding member 130 rotates in the left and right directions. Here, the fact that the height speaker 70A rotates in the left and right directions means that a height speaker 70A rotates around a second rotation axis (a, as shown in FIG. 6) which is disposed vertically.

Up-down and left-right rotation motions of the height speaker 70A will be described in detail with reference to FIGS. 6 to 8.

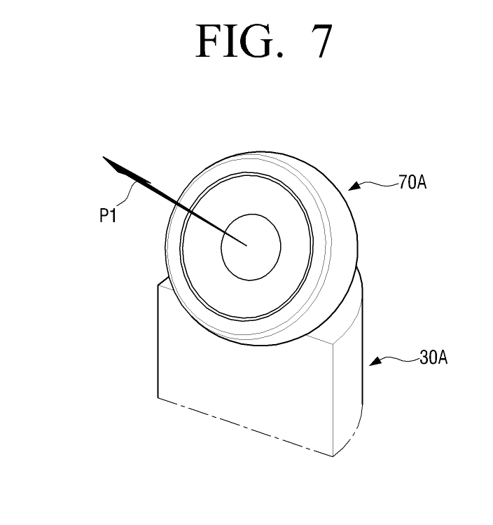

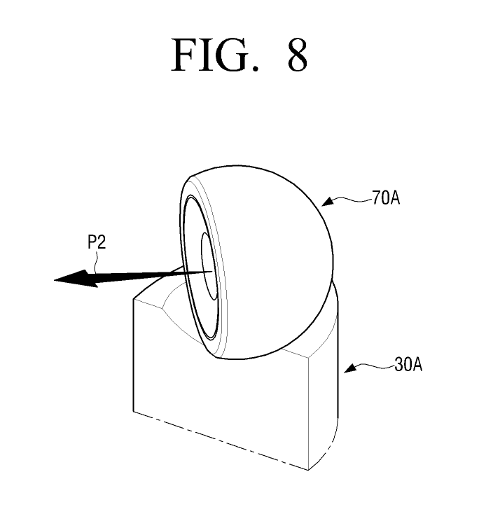

FIGS. 6 to 8 are drawings to explain rotation motions of a side speaker provided in an integrated speaker in FIG. 3, wherein FIG. 6 is an exemplary embodiment of a perspective view illustrating an initial state, FIG. 7 is an exemplary embodiment of a perspective view illustrating a case where a height speaker is rotated upward from an initial state, and FIG. 8 is an exemplary embodiment of a perspective view illustrating a case where a height speaker is rotated toward a right direction from an initial state.

As illustrated in FIG. 6, a height speaker 70A has a horizontal sound-emitting direction (i.e., a sound-emitting angle, P0) in an initial state.

If a height speaker 70A is rotated in the upper direction at a predetermined angle around a first rotation axis g that is substantially perpendicular to a vertical direction, a height speaker 70A has a sound-emitting direction P1 inclined upward as illustrated in FIG. 7.

If a height speaker 70A is rotated in the right direction at a predetermined angle around second rotation axis B which is disposed vertically, a side speaker 70A has a sound-emitting direction P1 inclined toward the right direction as illustrated in FIG. 8.

Accordingly, a height speaker 70A of an integrated speaker 100A may rotate toward a front speaker 30A relatively in the up-down and left-right directions. Accordingly, a sound-emitting direction of a height speaker 70A is appropriately adjustable in at least one of the up-down direction and the left-right direction. Therefore, a listener may appropriately select the sound-emitting direction of the height speaker 70A by considering listening conditions and a listener's preferences.

As in the above description, a length of a front speaker 30A is approximately lm. Accordingly, a height of a height speaker 70A is also 1 m. A 1 m height of a side speaker may be relatively low in comparison with a speaker attached on an interior wall. However, since a sound-emitting direction of a height speaker 70A may be adjusted to head upward as in FIG. 7, a three dimensional sound effect in the up-down direction provided by a height speaker 70A may be maintained even though a height of a height speaker 70A is relatively lowered.

In the above-mentioned exemplary embodiments, integrated speakers, 100A and 100B, were exemplified as an integration between height speakers 70A and 70B and front speakers 30A and 30B. However, it is understood that another exemplary embodiment is not limited thereto. For example, according to another exemplary embodiment, integrated speakers may be an integration between height speakers and rear speakers. However, if a height speaker is integrated into a front speaker, a sound output from a height speaker may be reflected on a ceiling and may be delivered to a listener better. Therefore, it may be preferable that a height speaker is integrated into a front speaker instead of a rear speaker, though it is understood that all exemplary embodiments are not limited thereto.

As described in the above, according to exemplary embodiments, since an integrated speaker which integrates a height speaker into a front speaker or a rear speaker is provided, inconvenience of an installation of a height speaker (i.e., a side speaker) on an interior wall may be eased. In addition, according to exemplary embodiments, since it is possible for a height speaker arranged in an integrated speaker to rotate in at least one of the up-down direction and the left-right direction, a listener may appropriately select a sound-emitting direction of a height speaker by considering listening conditions and a listener's preferences.

What is claimed is:

1. An integrated speaker comprising:
a first speaker which is configured to stand on a floor; and
a second speaker mounted to an upper end of the first speaker,
wherein the second speaker is a height speaker.

2. The integrated speaker as claimed in claim 1, wherein the first speaker is a front speaker.

3. The integrated speaker as claimed in claim 1, wherein the second speaker is rotatable around a first rotation axis that is perpendicular to a vertical direction.

4. The integrated speaker as claimed in claim 3, wherein the second speaker is rotatable around a second rotation axis that is parallel to the vertical direction.

5. The integrated speaker as claimed in claim 4, further comprising:
a connection unit which connects the first speaker and the second speaker,
wherein the upper end of the first speaker is a curved surface which has a predetermined curvature, and
wherein the connection unit comprises:
an axis member which is partly inserted into the first speaker through the curved surface, and
a sliding member which is coupled to the second speaker, has a sliding groove which has a long-hole shape and passed by the axis member, and has a plate shape which has a same curvature as the curved surface.

6. The integrated speaker as claimed in claim 1, wherein the first speaker is a rear speaker.

7. The integrated speaker as claimed in claim 1, wherein the second speaker is rotatable around a second rotation axis that is parallel to a vertical direction.

8. The integrated speaker as claimed in claim 7, further comprising:
a connection unit which connects the first speaker and the second speaker,
wherein the upper end of the first speaker is a curved surface which has a predetermined curvature, and
wherein the connection unit comprises:
an axis member which is partly inserted into the first speaker through the curved surface, and
a sliding member which is coupled to the second speaker, has a sliding groove which has a long-hole shape and passed by the axis member, and has a plate shape which has a same curvature as the curved surface.

9. The integrated speaker as claimed in claim 3, further comprising:
a connection unit which connects the first speaker and the second speaker,
wherein the upper end of the first speaker is a curved surface which has a predetermined curvature, and
wherein the connection unit comprises:
an axis member which is partly inserted into the first speaker through the curved surface, and
a sliding member which is coupled to the second speaker, has a sliding groove which has a long-hole shape and passed by the axis member, and has a plate shape which has a same curvature as the curved surface.

10. A home theater sound system comprising an integrated speaker, wherein the integrated speaker comprises:
a first speaker which is configured to stand on a floor; and
a second speaker mounted to an upper end of the first speaker,
wherein the second speaker is a height speaker.

11. The home theater sound system as claimed in claim 10, wherein the first speaker is a front speaker.

12. The home theater sound system as claimed in claim 10, wherein the second speaker is rotatable around a fist rotation axis that is perpendicular to a vertical direction.

13. The home theater sound system as claimed in claim 12, wherein the second speaker is rotatable around a second rotation axis that is parallel to the vertical direction.

14. The home theater sound system as claimed in claim 13, further comprising a connection unit which connects the first speaker and the second speaker,
wherein the upper end of the first speaker is a curved surface which has a predetermined curvature, and
wherein the connection unit comprises:
an axis member partly inserted into the first speaker through the curved surface, and
a sliding member which is coupled to the second speaker, has a sliding groove which has a long-hole shape and passed by the axis member, and has a plate shape which has a same curvature as the curved surface.

15. The home theater sound system as claimed in claim 11, wherein the home theater sound system is a 7.1 channel home theater sound system, wherein the integrated speaker is disposed at a front left location, the home theater sound system further comprising:
another integrated speaker disposed at a front right location;
two rear speakers disposed in a rear left location and a rear right location, respectively;
a center speaker disposed between the two integrated speakers; and
a sub-woofer which reinforces reproduction of a low sound.

16. The home theater sound system as claimed in claim 10, wherein the first speaker is a rear speaker.
